(19) United States
(12) Patent Application Publication
(10) Pub. No.: US 2010/0013453 A1
(43) Pub. Date: Jan. 21, 2010

(54) DC/DC CONVERTER, COMPUTER SYSTEM HAVING THE SAME, AND DC/DC CONVERSION METHOD

(75) Inventor: Jae-deok CHA, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/411,531

(22) Filed: Mar. 26, 2009

(30) Foreign Application Priority Data
Jul. 15, 2008 (KR) 2008-68706

(51) Int. Cl. H02M 3/156

(52) U.S. Cl. 323/351

(57) ABSTRACT

A computer system including the same, and a DC/DC conversion method. The DC/DC converter includes: a filter part receiving an input voltage and outputting an output voltage converted in level from the input voltage; a plurality of switching parts switching so that the input voltage is selectively supplied to the filter part, wherein the switching parts are connected in parallel to the filter part at a phase voltage terminal; and a controller sequentially controlling switching of the plurality of switching parts so that the output voltage reaches a predetermined target value.

### CROSS-REFERENCE TO RELATED APPLICATION

This application claims the benefit of Korean Patent Application No. 2008-68706, filed Jul. 15, 2008 in the Korean Intellectual Property Office, the disclosure of which is incorporated herein by reference.

### BACKGROUND OF THE INVENTION

1. Field of the Invention

Aspects of the present invention relate to a DC/DC converter which is capable of operating at a high switching frequency, a computer system having the DC/DC converter, and a DC/DC conversion method therein.

2. Description of the Related Art

In general, a computer system such as a desktop or a laptop is provided with an internal or external power supply for supplying operational power. The power supply may have a DC/DC converter for supplying DC power to the computer system. A switched mode DC/DC converter is usually used as the computer DC/DC converter for efficiency, or other reasons.

The following considerations may be given in design of the switched mode DC/DC converter:

First, ripples of an output current and an output voltage need to satisfy design specifications (for example, need to be within a predetermined value range).

Second, as the capacities of a filter inductor and a filter capacitor become smaller, the costs of such become less expensive and the sizes of such become smaller.

However, a cutoff frequency, determined by the filter inductor and the filter capacitor, should be smaller than a switching frequency to secure a required filtering function, and thus, there is a limit in reducing inductance of the filter inductor in order to reduce the size of such.

On the other hand, it is possible to reduce ripples of an output current by increasing a switching frequency. However, the switching frequency cannot be increased over a certain limit due to characteristics of MOSFETs, or other similar components, which are used as a switching elements of the switched mode DC/DC converter.

### SUMMARY OF THE INVENTION

Accordingly, aspects of the present invention provide a DC/DC converter which can minimize the cost and size of such while satisfying design specifications for ripples of an output voltage and an output current, an output transient response, etc.; a computer system having the same; and a DC/DC conversion method.

Additionally, aspects of the present invention provide a DC/DC converter including: a filter part receiving an input voltage and outputting an output voltage converted in level from the input voltage; a plurality of switching parts switching so that the input voltage is selectively supplied to the filter part, wherein the switching parts are connected in parallel to the filter part at a phase voltage terminal; and a controller sequentially controlling switching of the plurality of switching parts so that the output voltage reaches a predetermined target value.

The controller may control the switching of the plurality of the switching parts so that a frequency of the output voltage is a multiple of a switching frequency of each of the plurality of the switching parts.

The controller may control the switching of the plurality of switching parts sequentially.

Each of the plurality of switching parts, under control of the controller, may include: a control field effect transistor (FET) switching so that the input voltage is selectively supplied to the filter part; and a synchronous FET freewheeling a current flowing in the filter part if the control FET is opened.

The controller may open the control FETs and the synchronous FETs in a remaining plurality of the switching parts, if one of either the control FET or the synchronous FET in one of the plurality of the switching parts is closed.

The filter part may include: a filter inductor which stores energy of the input voltage; and a filter capacitor which outputs the output voltage.

Additionally, aspects of the present invention provide a computer system including: a system unit executing a computer program to process data; and a DC/DC converter supplying operational power to the system unit. Here, the DC/DC converter includes: a filter part receiving an input voltage and outputs an output voltage, converted in level from the input voltage, as the operational voltage of the system unit; a plurality of switching parts connected in parallel to the filter part at a phase voltage terminal and performing switching so that the input voltage is selectively supplied to the filter part; and a controller sequentially controlling switching of the plurality of switching parts so that the output voltage reaches a predetermined target value.

The controller may control the switching of the plurality of the switching parts so that a frequency of the output voltage is a multiple of a switching frequency of each of the plurality of the switching parts.

The controller may control the switching of the plurality of the switching parts sequentially.

Each of the plurality of switching parts, under the control of the controller, may include: a control FET which performs switching so that the input voltage is selectively supplied to the filter part; and a synchronous FET which freewheels a current flowing in the filter part if the control FET is opened.

The controller may open the control FETs and synchronous FETS in a remaining plurality of the switching parts, if one of either the control FET or the synchronous FET in one of the plurality of the switching parts is closed.

The filter part includes: a filter inductor which stores energy of the input voltage; and a filter capacitor which outputs the output voltage.

Additionally, aspects of the present invention provide a DC/DC conversion method including: switching one of a plurality of switching parts which is connected in parallel to a filter part at a phase voltage terminal and switching so that an input voltage is selectively supplied, wherein the one of the plurality of the switching parts converts the voltage level of the input voltage for outputting an output voltage; and sequentially switching the other of the plurality of the switching parts so that the output voltage reaches a predetermined target value.

A frequency of the output voltage may be a multiple of a switching frequency of each of the plurality of the switching parts.

The plurality of the switching parts may be selectively switched one by one, in the sequentially switching.

Each of the plurality of switching parts may include: a control FET which performs switching so that the input voltage is selectively supplied to the filter part; and a synchronous FET which freewheels a current flowing in the filter part if the control FET is opened.

If either one of the control FET or the synchronous FET in one of the plurality of switching parts is closed, the control FETs and the synchronous FETs in a remaining plurality of switching parts are opened.

The filter part may include: a filter inductor which is capable of storing energy of the input voltage; and a filter capacitor which outputs the output voltage.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a computer system 1 according to an exemplary embodiment of the present invention;

FIG. 2 illustrates a DC/DC converter according to an exemplary embodiment of the present invention;

FIG. 3 illustrates a control signal, a phase voltage and an output current according to an exemplary embodiment of the present invention;

FIG. 4 illustrates a multi-phase DC/DC converter according to a comparative example with respect to an exemplary embodiment of the present invention;

FIG. 5 illustrates a control signal, a phase voltage and an outputting current by the DC/DC converter in FIG. 4; and

FIG. 6 illustrates a DC/DC conversion method according to an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

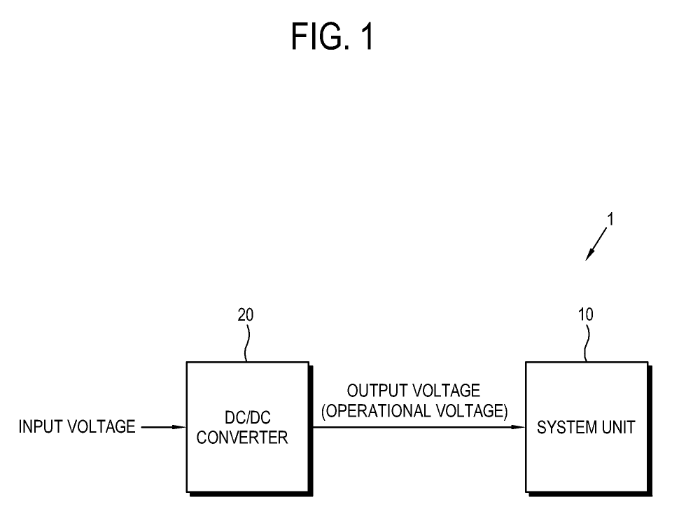

FIG. 1 illustrates a computer system 1 according to an embodiment of the present invention. The computer system 1 may be embodied as a desktop computer, a laptop computer, a mobile device, a consumer electronic device, a video or audio device, a telecommunications device, an electronic device with an embedded computer, or the like. As shown in FIG. 1, the computer system 1 may include a system unit 10 and a DC/DC converter 20.

The system unit 10 processes data according to execution of a computer program. The system unit 10 may include: a ROM for storing the computer program and a hard disk drive; a CPU for executing a RAM for loading the computer program and the computer program loaded in the RAM; a north bridge (or MCH: Memory Controller Hub) and a south bridge (or ICH: Input/Output Controller Hub) for performing an interface; and a graphic controller, a sound controller, a network controller, a USB controller, a mouse, a keyboard, a display, a CD/DVD, or the like.

The DC/DC converter 20 performs a part of power supply functions (not shown) supplying power to the system unit 10. The DC/DC converter 20 outputs an operational voltage of the system unit 10 having converted a voltage level of a DC input voltage.

The DC/DC converter 20 may receive as the input voltage a DC voltage outputted from a rectifying/smoothing device (not shown) which receives and rectifies/smoothes an AC voltage. The computer system 1 may further include the rectifying/smoothing device for outputting the DC voltage to the DC/DC converter 20. The DC/DC converter 20 may be provided as a separate device, or may be provided integrally with the rectifying/smoothing device.

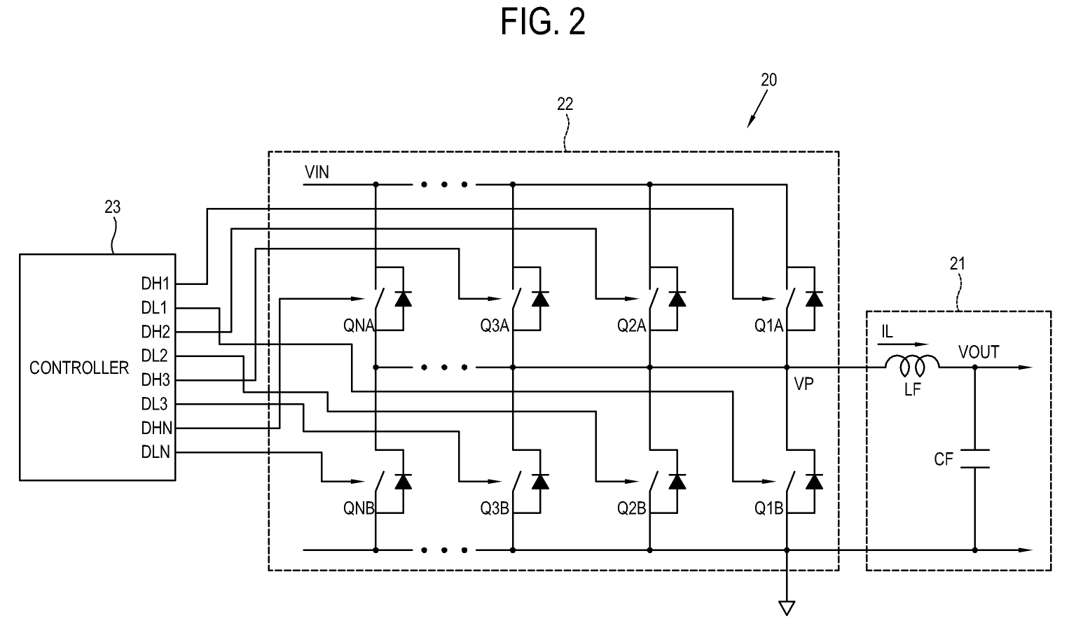

FIG. 2 illustrates the DC/DC converter 20 according to an exemplary embodiment of the present invention. The DC/DC converter 20 may be a synchronous buck converter. As shown in FIG. 2, the DC/DC converter 20 includes: a filter part 21 receiving an input voltage (VIN) and outputs an output voltage (VOUT) converted in level from an input voltage (VIN) as an operational voltage of the system unit 10; a plurality of switching parts 22 each connected in parallel to the filter part 21 and performing switching so that the input voltage (VIN) is selectively supplied to the filter part 21; and a controller sequentially controlling switching of the plurality of switching parts 22 so that the output voltage (VOUT) reaches a predetermined target value.

The filter part 21 may include a filter inductor (LF) in which energy of the input voltage (VIN) can be stored; and a filter capacitor (CF) outputting the output voltage (VOUT). The filter part 21 performs low-pass filtering based on a cutoff frequency determined by reactance of the filter inductor (LF) and the filter capacitor (CF).

Each of the plurality of switching parts 22 include a pair of switching elements (hereinafter, referred to as an ‘arm’) each arranged in upper terminals (Q1A, Q2A . . . , QNA) and lower terminals (Q1B, Q2B . . . , QNB). Each arm is connected in parallel to the filter inductor (LF) at a phase voltage (VP) terminal.

Each arm, under control of the controller 23, includes: control FETs (Q1A, Q2A . . . , QNA) performing switching so that the input voltage (VIN) is selectively supplied to the filter part 21; and synchronous FETs (Q1B, Q2B . . . , QNB) free-wheeling an output current (IL) flowing in the filter part 21 if the control FETs (Q1A, Q2A . . . , QNA) are opened.

The controller 23 includes a plurality of output ports (DH1, DL1, DH2, DL2, . . . , DHN and DLN) respectively outputting control signals to the plurality of control FETs (Q1A, Q2A, . . . and QNA) and the plurality of synchronous FETs (Q1B, Q2B, . . . and QNB), and sequentially switches the plurality of switching parts 22 one by one. The controller 23, receives the output voltage (VOUT) and/or the output current (IL) as feedback (not shown), and controls the plurality of switching parts 22 so that the output voltage (VOUT) reaches a predetermined target value. The controller 23 may perform control in a pulse width modulation (PWM) method.

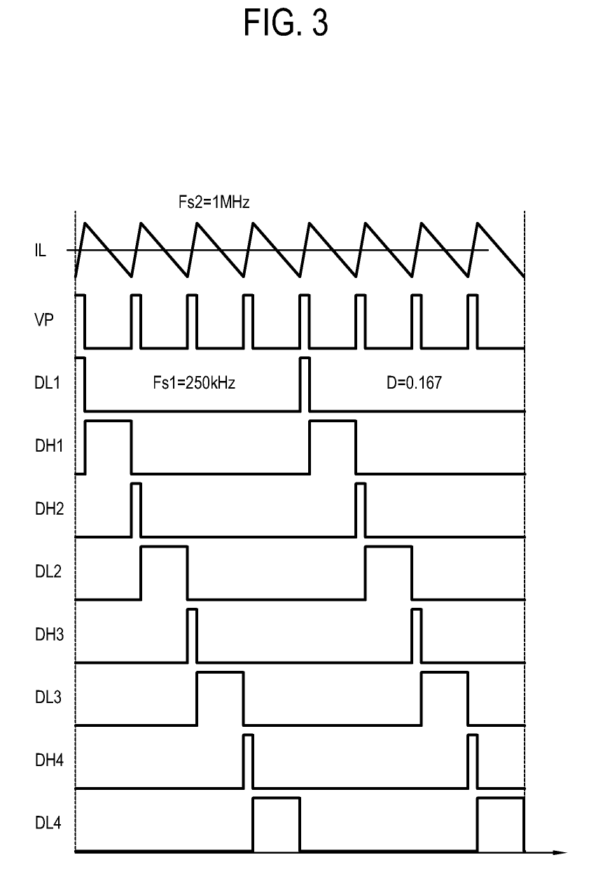

FIG. 3 illustrates waveforms of control signals (refer to DH1, DL1, DH2, DL2, DH3, DL3, DH4 and DL4), a phase voltage (VP) and an output current (IL) according to an embodiment of the present invention. For the convenience of description, the waveforms of control signals of four switching parts 22 are illustrated, but the embodiment is not limited thereto.

The controller 23 sequentially performs switching to a first control FET (Q1A) and a first synchronous FET (Q1B) (refer to DH1 and DL1) to a fourth control FET (Q4A) and a fourth synchronous FET (Q4B). As shown in FIG. 3, the controller 23 again performs switching to the pair of the first control FET (Q1A) and the first synchronous FET (Q1B), if switching to a pair of a second control FET (Q2A) and a second synchronous FET (Q2B) and a pair of a third control FET (Q3A) and a third synchronous FET (Q3B) terminates (with reference to FIG. 3, shown as DH2 and DL2, and DH3 and DL3), and then switching of a pair of the fourth control FET (Q4A) and the fourth synchronous FET (Q4B) terminates (with reference to FIG. 3, shown as DH4 and DL4).

In switching to each arm (DH1 and DL1, DH2 and DL2, DH3 and DL3, and DH4 and DL4), the controller 23 turns on and then off the control FETs (Q1A, Q2A, Q3A and Q4A) at a predetermined duty ratio (D), and turns on the synchronous FETs (Q1B, Q2B, Q3B and Q4B). According to the present embodiment, the synchronous FETs (Q1B, Q2B, Q3B and Q4B) may firstly be turned on just before the control FETs (Q1A, Q2A, Q3A and Q4A) is turned off.

Further, the controller 23 terminates switching to one of the arms (refer to DH1 and DL1, DH2 and DL2, DH3 and DL3, and DH4 and DL4), and then, performs switching to the next one of the arms (refer to DH1 and DL1, DH2 and DL2, DH3 and DL3, and DH4 and DL4). During performing switching to one of the arms (refer to DH1 and DL1, DH2 and DL2, DH3 and DL3, and DH4 and DL4), the other of the arms (refer to DH1 and DL1, DH2 and DL2, DH3 and DL3, and DH4 and DL4) may be turned off.

Referring to FIG. 2, if one of the control FETs (Q1A, Q2A, Q3A and Q4A) is turned on, and one of the synchronous FETs (Q1B, Q2B, Q4B and Q4B) is turned off, an input voltage (VIN) is supplied to the filter inductor (LF), and thus, an output current (IL) flows in the filter inductor (LF), and an output voltage (VOUT) is outputted by the filter capacitor (CF). In this case, current energy is stored in the filter inductor (LF), and the output current (IL) increases.

With reference to FIG. 2, if one of the control FETs (Q1A, Q2A, Q3A and Q4A) is turned off, and one of the synchronous FETs (Q1B, Q2B, Q3B and Q4B) is turned on, the input voltage (VIN) is not supplied to the filter inductor (LF). In this case, the corresponding synchronous FETs (Q1B, Q2B, Q3B and Q4B), the filter inductor (LF) and the filter capacitor (CF) form a closed loop, and thus, an input current (IL) flows by the current energy stored in the filter inductor (LF), and an output voltage (VOUT) is outputted by the filter capacitor (CF). In this respect, the current energy of the filter inductor (LF) is discharged, and an output current (IL) is decreased.

The controller 23 may make the duty ratios (D) with respect to the respective arms (DH1 and DL1, DH2 and DL2, DH3 and DL3, and DH4 and DL4) equivalent. The duty ratio (D) according to the present embodiment may be 0.167.

In the embodiment in FIG. 3, a switching frequency (Fs1) of the respective arms (DH1 and DL1, DH2 and DL2, DH3 and DL3, and DH4 and DL4) is 250 kHz. Since the number of the arms (DH1 and DL1, DH2 and DL2, DH3 and DL3, and DH4 and DL4) is four, a switching frequency (Fs2) of the phase voltage (VP) terminal is 250 kHz*4, that is, 1 MHz.

As described above, according to the present embodiment, the plurality of arms is connected in parallel and is sequentially switched, thus, the switching frequency of the phase voltage (VP) terminal can be greatly increased without increasing the capacity of the switching frequency of each arm.

If a switching frequency can be increased, the possibility of increasing a cutoff frequency is sufficiently secured, and consequently, inductance of the filter (LF) is decreased, the size of an LC filter can be decreased, and the cost thereof can be lowered.

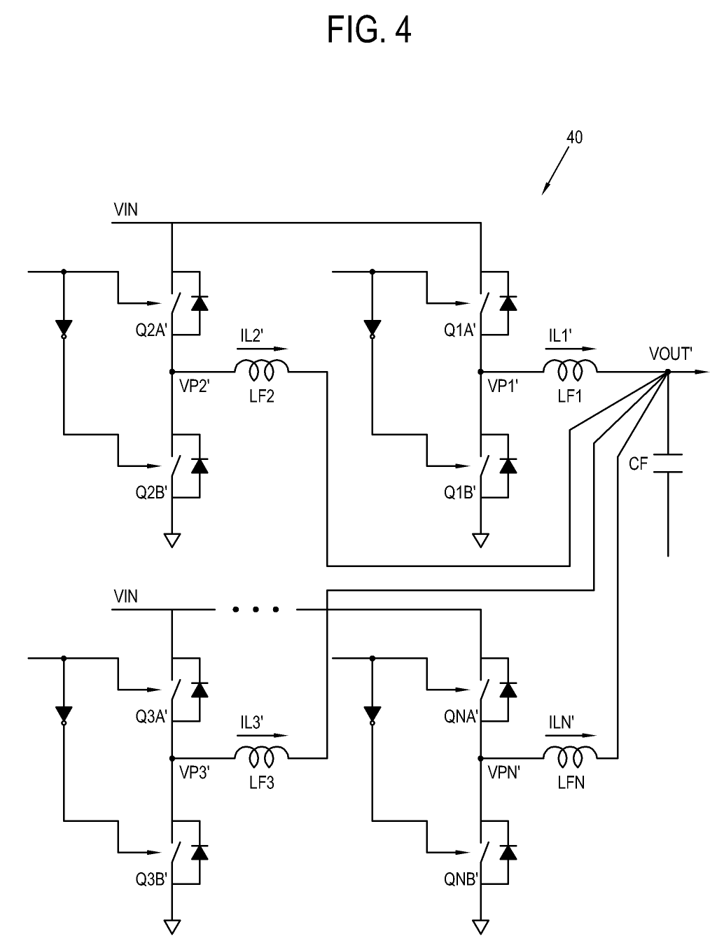

FIG. 4 illustrates a comparative example in which a switching frequency increases in a multi phase method. A DC/DC converter 40 shown in FIG. 4 is provided with filter inductors (LF1′, LF2′ . . . , and LFN′) with respect to the respective arms (Q1A′ and Q1B′, Q2A′ and Q2B′ . . . , and QNA′ and QNB′).

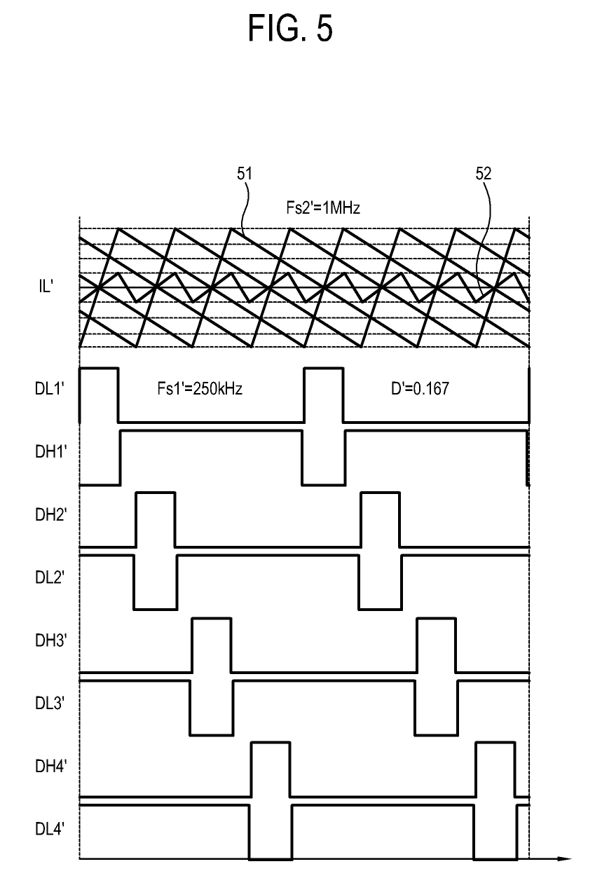

FIG. 5 illustrates waveforms of control signals (refer to DH1′, DL1′, DH2′, DL2′, DH3′, DL3′, DH4′ and DL4′) and an output current (IL′) in the DC/DC converter 40. For the convenience of description, the number of arms of the DC/DC converter 40 is four by way of example. In FIG. 5, the output current (IL′) is the sum of inductor currents (IL1′, IL2′, IL3′ and IL4′) of the respective arms. Reference numeral 51 represents a single phase corresponding to the respective arms (Q A′ and Q1B′, Q2A′ and Q2B′, Q3A and Q3B′, and Q4A′ and Q4B′); and reference numeral 52 represents a multi phase of a final output terminal (VOUT′).

Hereinafter, the DC/DC converter 20 according to the present embodiment in FIGS. 2 and 3 and the DC/DC converter 40 according to the comparative example in FIGS. 4 and 5 will be compared with each other.

The DC/DC converters 20 and 40 are the same in that switching frequencies (Fs1 and Fs1′) of the respective arms are 250 kHz, duty ratios (D and D′) for both are 0.167, and output currents (IL and IL′) for both are 1 MHz.

However, a switching frequency at the phase voltage (VP) terminal is 1 MHz in the DC/DC converter 20 according to the present embodiment, whereas a switching frequency at the phase voltage (VP1′, VP2′, VP3′ and VP4′) terminals is only 250 kHz in the DC/DC converter 40 according to the comparative example.

In other words, according to the present embodiment, a switching frequency can be increased at the phase voltage (VP) terminal, and thus, inductance of the filter inductor (LF) can be decreased, to thereby decrease the size of the LC filter and the cost thereof, whereas a switching frequency at the phase voltage (VP1′, VP2′, VP3′ and VPN′) terminals cannot be increased, and thus, the above effect cannot be accomplished.

Also, the DC/DC converters 20 and 40 differ in that the DC/DC converter 20 according to the present embodiment includes one filter inductor (LF), whereas the DC/DC converter 40 according to the comparative example includes the plurality of filter inductors (LF1′, LF2′ . . . and LFN′). Thus, according to the present embodiment, the number of the filter inductors can be decreased while satisfying design specification such as output transient response, ripples of an output voltage and an output current, and thus, the cost and the size thereof can be decreased, compared with the comparative example.

Further, according to the present embodiment, phase unbalance can be removed, fast transient response can be realized, and EMI and noise immunity can be improved.

Furthermore, according to the present embodiment, components such as a current sensor and a droop controller necessary for every phase in the multi-phase method, can be realized as a single block in a simple way with a low cost.

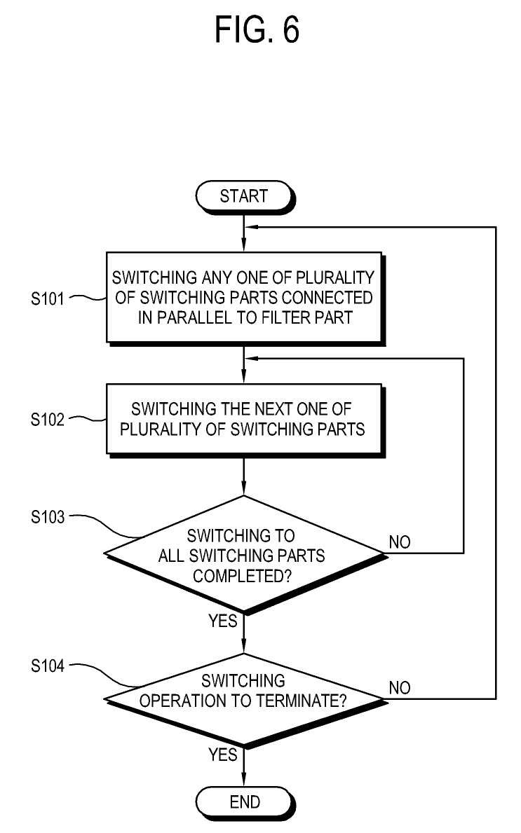

FIG. 6 illustrates a DC/DC conversion method according to an exemplary embodiment of the present invention. The DC/DC conversion method may be performed by the DC/DC converter 20 as shown in FIGS. 1 to 3.

First, one of the plurality of switching parts 22 connected in parallel to the filter part 21 at the phase voltage (VP) terminal is switched so that an output voltage (VOUT) reaches a predetermined target value (S101). The switched one of the plurality of switching parts may be the first control FET (Q1A) and the first synchronous FET (Q1B).

Then, the next one of the plurality of switching parts 22 is switched so that the output voltage (VOUT) reaches a predetermined target value (S102). The next one switching part may be the second control FET (Q2A) and the second synchronous FET (Q2B).

Next, it is confirmed whether all the plurality of switching parts is switched (S103). If it is confirmed that all the plurality of switching parts is not switched, the process returns to operation S102, and the next one of the plurality of switching parts 22 is switched. The next one switching part 22 may be the third control FET (Q3A) and the third synchronous FET (Q3B).

If it is confirmed in operation S103 that all the plurality of switching parts 22 is switched, for example, switching to the fourth control FET (Q4A) and the fourth synchronous FET (Q4B) is completed, it is confirmed whether the switching operation is to terminate (S104).

If it is confirmed in operation S104 that the switching operation is not to terminate, the process returns to S101 to repeat operations S101 through S104.

If it is confirmed in operation S104 that the switching operation is to terminate, all operations terminate.

According to alternative embodiments, operations S103 and S104 may be exchanged in order. Further, at least one of operations S103 and S104 may be performed between operations S101 and S102. Furthermore, operation S104 may be omitted.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A DC/DC converter comprising:
a filter part receiving an input voltage and outputting an output voltage converted in level from the input voltage;
a plurality of switching parts switching so that the input voltage is selectively supplied to the filter part, wherein the switching parts are connected in parallel to the filter part at a phase voltage terminal; and
a controller sequentially controlling switching of the plurality of switching parts so that the output voltage reaches a predetermined target value.

2. The DC/DC converter according to claim 1, wherein the controller controls the switching of the plurality of the switching parts so that a frequency of the output voltage is a multiple of a switching frequency of each of the plurality of the switching parts.

3. The DC/DC converter according to claim 2, wherein the controller controls the switching of the plurality of the switching parts sequentially.

4. The DC/DC converter according to claim 1, wherein each of the plurality of the switching parts, under the control of the controller, comprises:
a control field effect transistor (FET) switching so that the input voltage is selectively supplied to the filter part; and
a synchronous FET freewheeling a current flowing in the filter part if the control FET is opened.

5. The DC/DC converter according to claim 4, wherein the controller opens the control FETs and the synchronous FETs in a remaining plurality of the switching parts, if one of the control FET and the synchronous FET in one of the plurality of the switching parts is closed.

6. The DC/DC converter according to claim 5, wherein the filter part comprises:
a filter inductor which stores energy of the input voltage; and
a filter capacitor which outputs the output voltage.

7. A computer system comprising:
a system unit executing a computer program to process data; and
a DC/DC converter supplying operational power to the system unit, wherein the DC/DC converter comprises:
a filter part receiving an input voltage and outputs an output voltage, converted in level from the input voltage, as the operational voltage of the system unit;
a plurality of switching parts connected in parallel to the filter part at a phase voltage terminal and performing switching so that the input voltage is selectively supplied to the filter part; and
a controller sequentially controlling switching of the plurality of the switching parts so that the output voltage reaches a predetermined target value.

8. The computer system according to claim 7, wherein the controller controls switching of the plurality of the switching parts so that a frequency of the output voltage is a multiple of a switching frequency of each of the plurality of the switching parts.

9. The computer system according to claim 8, wherein the controller controls the switching of the plurality of the switching parts sequentially.

10. The computer system according to claim 7, wherein each of the plurality of switching parts, under the control of the controller, comprises:
a control field effect transistor (FET) which performs switching so that the input voltage is selectively supplied to the filter part; and
a synchronous FET which freewheels a current flowing in the filter part if the control FET is opened.

11. The computer system according to claim 10, wherein the controller opens the control FETs and the synchronous FETs in a remaining plurality of the switching parts, if one of the control FET and the synchronous FET in one of the plurality of the switching parts is closed.

12. The computer system according to claim 11, wherein the filter part comprises:
a filter inductor which stores energy of the input voltage; and
a filter capacitor which outputs the output voltage.

13. A DC/DC conversion method, comprising:
switching one of a plurality of switching parts connected in parallel to a filter part at a phase voltage terminal and switching so that an input voltage is selectively supplied, wherein the one of the plurality of the switching parts converts the voltage level of the input voltage for outputting an output voltage; and
sequentially switching the other of the plurality of the switching parts so that the output voltage reaches a predetermined target value.

14. The method according to claim 13, wherein a frequency of the output voltage is a multiple of a switching frequency of each of the plurality of the switching parts.

15. The method according to claim 14, wherein the plurality of the switching parts is selectively switched one by one, in the sequentially switching.

16. The method according to claim 13, wherein each of the plurality of the switching parts comprises:
a control field effect transistor (FET) which performs switching so that the input voltage is selectively supplied to the filter part; and
a synchronous FET which freewheels a current flowing in the filter part if the control FET is opened.

17. The method according to claim 16, wherein if one of the control FET and the synchronous FET in one of the plurality of the switching parts is closed, the control FETs and the synchronous FETs in a remaining plurality of the switching parts are opened.

18. The method according to claim 17, wherein the filter part comprises:
a filter inductor which is capable of storing energy of the input voltage; and
a filter capacitor which outputs the output voltage.

19. A DC/DC conversion method, comprising:
receiving an input voltage; and
converting an input voltage level of the input voltage to a predetermined output voltage level of an output voltage by sequentially switching a plurality of switching parts to convert the input voltage level to the predetermined output voltage level, wherein the plurality of the switching parts are connected in parallel to a filter part.
